(19) United States
(12) Patent Application Publication
(10) Pub. No.: US 2024/0200590 A1
(43) Pub. Date: Jun. 20, 2024

(54) RETAINING NUT

(71) Applicant: BIZLINK INDUSTRY GERMANY GMBH, Roth (DE)

(72) Inventors: Philipp KNAUER, Lisberg (DE); Peter LEHMANN, Absberg (DE)

(21) Appl. No.: 17/916,518

(22) PCT Filed: Mar. 11, 2021
(86) PCT No.: PCT/DE2021/000046

§ 371 Date: Apr. 7, 2023

(30) Foreign Application Priority Data
Apr. 2, 2020 (DE) 10 2020 002 123.9

(51) Int. Cl. F16B 9/00; F16B 33/00; F16B 37/12

(52) U.S. Cl. CPC F16B 9/056; F16B 37/125; F16B 33/004

(57) ABSTRACT

The invention relates to a retaining nut (1) for a threaded cable connection which is provided for special installation situations. Here, a subsequent assembly of the retaining nut on a cable (60) with an integrated cable sleeve (70) is not possible. According to the invention, the retaining nut (1) has a two-part construction comprising a main part (10) and a ring (15). By virtue of the two-part retaining nut (1), it is possible to arrange the ring (15) on the cable (60) behind the cable sleeve (70) at an earlier point in time in the assembly process. In this manner, the assembly of the cable (60) with the cable sleeve (70) and the ring (15) is ensured and a subsequent connection of the main part (10) and the ring (15) is made possible.

The application is based on a retaining nut according to the preamble of independent claim 1.

Such retaining nuts are required for threaded cable connections. Here, a cable is guided through a feedthrough and/or sleeve on which the cable is to be fastened. The fastening of the cable is often combined with the simultaneous sealing of the cable. The retaining nut is required to fix and/or seal the cable to or on the feedthrough by means of a seal, a clamping part or a sleeve.

Retaining nuts usually have a stepped or conically tapering inner side on which a clamping part or a seal is clamped or compressed. Here, the retaining nut is screwed to a base part of the threaded cable connection. The seal, sleeve or clamping part, which is arranged between the base part and the retaining nut, is compressed radially inward when this is done. By means of the compression, the fed-through cable is fixed in a force-fitting manner. Often, an environmentally sealed connection is thus also made possible.

A large number of threaded cable connections and retaining nuts for such are known from the prior art. When assembling a threaded cable connection, the retaining nut is first pushed onto the cable, then the seal or the clamping part, followed by a screw base body. Often, the seal or the clamping part is already contained in the base body or is integrally connected thereto.

Special measures are provided for special application, particularly in cases where a great many environmental influences have a negative effect on the threaded cable connection. For this purpose, the seal is often applied to the cable as an integral component. For this purpose, a so-called cable sleeve is sprayed onto the cable or glued to it during the assembly of the cable. The cable sleeve has various tasks. On the one hand, it forms the seal. The spraying or gluing on the cable thus produces a particularly environmentally tight connection.

On the other hand, a better mechanical fixing of the cable in the threaded cable connection is possible in this way. At the same time, the cable sleeve is often made somewhat longer and thus also acts as an anti-bend protection for the cable. Especially in the area of the threaded cable connection, strong forces act on a cable and thus can quickly lead to bending of the cable. Such an anti-bend protection prevents this.

A disadvantage of the solutions for threaded cable connections known from the prior art is the assembly sequence. Accordingly, there are installation situations in which the known sequence of assembly is not possible. This is especially the case when the installation situation is designed such that the cable, together with the screw connection and cable sleeve, has to be guided through a narrow opening. However, since the retaining nut of the threaded cable connection has to be pushed onto the cable prior to the molding on of the cable sleeve, it no longer fits through an opening that is smaller than the retaining nut itself.

For this application as well, there already exists a solution in the prior art. These provide, for example, retaining nuts which consist of two half nuts and can be subsequently arranged around the cable by means of a bayonet mechanism. However, the disadvantage of this type of retaining nuts is that they cannot absorb large mechanical forces. This has a negative effect especially in areas with high environmental impact. Although cable screw connections can be retrofitted with such retaining nuts, they do not meet the necessary requirements for mechanical load-bearing capacity and tightness.

### Problem Definition

The object of the present invention is to provide a retaining nut for a threaded cable connection which is suitable for use with very narrow cable feedthroughs. Here the retaining nut should withstand high mechanical loads. At the same time, the retaining nut must fit through a narrow opening and also enable assembly if a cable sleeve or an anti-kink protection is already attached to a cable.

The object is achieved by the characterizing features of the subject matter of independent claim 1.

Advantageous embodiments of the invention are specified in the subclaims.

The invention is a retaining nut for a threaded cable connection. The retaining nut is provided to act on a clamping or sealing part with a base body of a threaded cable connection that interacts with the retaining nut. In this case, the damping or sealing part is pressed between the retaining nut and the base body in such a way that the clamping or sealing part exerts a radially inwardly directed force. The radially inwardly directed force of the damping or sealing part is provided for mechanically fixing and/or sealing a cable guided through the threaded cable connection.

The retaining nut essentially has a circular outer surface; an angular design would also be possible. A through-opening forms an inner surface. The inner surface is expediently made cylindrical and has a first internal thread. By means of the first internal thread, the retaining nut can be screwed onto a base body of the threaded cable connection. For this purpose, a base body of a threaded cable connection can be screwed into the first internal thread of the retaining nut on a screw-in side.

Opposite the screw-in side, the retaining nut forms a feedthrough side which is designed for receiving and guiding through a cable. Such a cable can be inserted into the retaining nut in the feedthrough side and passed through the retaining nut up to the screw-in side.

Expediently, a first inner diameter is provided on the screw-in side of the retaining nut, which at the same time forms the diameter of the first internal thread, wherein a second inner diameter is provided on the feedthrough side of the retaining nut. Here the second inner diameter is smaller than the first inner diameter.

In a preferred embodiment of the invention, a pressing region is provided in the region between the first inner diameter and the second inner diameter. The pressing region is not formed as a step between the first inner diameter and the second inner diameter, but follows a conical profile. That is, in the pressing region the inner surface of the retaining nut tapers conically to the second inner diameter from the first inner diameter.

This preferred embodiment of the retaining nut enables a particularly advantageous transmission of force to a clamping or sealing part arranged in the retaining nut. A radially inwardly-directed force can advantageously be applied to the damping or sealing part by the conical pressing region. The better this force is exerted on a clamping or sealing part, the better a frictional connection to the cable can be produced. In addition, this has a better effect on the tightness of the threaded cable connection to the cable.

According to the invention, the retaining nut is formed in two parts. The retaining nut consists of a base body and a ring. The ring can be inserted into the base body in such a way that the base body encloses the ring at least in regions. The inner surface forms a first inner surface on the base body and a second inner surface on the ring. In a particularly preferred embodiment, the ring is accommodated completely in the base body. The ring can expediently be inserted into the base body on the feedthrough side.

So that the base body and the ring enable a fixed connection to one another, an external thread is formed on the ring, which thread is formed around the ring. The external thread is provided for screwing into a second internal thread. The second internal thread is expediently formed in the base body on the feedthrough side of the retaining nut. The ring can thus be screwed into the base body of the retaining nut on the feedthrough side.

Another embodiment provides for the outer thread of the ring and the second internal thread of the main body to be replaced with another possibility for locking. Thus, a kind of bayonet lock is also possible. For this purpose, the ring would be provided with locking lugs and the base body would be provided with recesses. By inserting the locking lugs into the recesses of the base body while simultaneously rotating the base body and the ring relative to each other, a connection can also be enabled.

In a specific embodiment of the invention, the first internal thread and the second internal thread are formed as a single thread extending through the base body. This means that the thread extends from the screw-in side as the first internal thread to the feedthrough side as the second internal thread. In this embodiment, the first internal thread and the second internal thread expediently have the same size and pitch.

A preferred embodiment of the invention provides that the first inner diameter of the retaining nut is arranged on the base body and the second inner diameter is arranged on the ring. As a result of this particularly advantageous arrangement of the first and second inner diameters, a particularly favorable mounting of the retaining nut on a cable is possible. It is possible for the cable to be laid and installed with the ring already arranged on the cable in regions which are too narrow for the entire retaining nut.

A cable with ring can thus be guided through openings which are only minimally larger than the ring itself. That is to say, the opening has to be only slightly larger than the first inner diameter of the retaining nut. For example, in this way a cable can be provided with a cable sleeve, which acts simultaneously as a clamping and sealing part. As a result of the ring being pushed onto the cable beforehand, the ring is held on the cable by the cable sleeve. Both the ring and the cable sleeve here correspond, at maximum, to the first inner diameter of the retaining nut. The cable can be laid with the ring and cable sleeve arranged thereon and/or can be pushed through openings which provide only somewhat more space than the first inner diameter.

After installation of the cable with cable sleeve and ring, the base body of the retaining nut, which is larger than the first inner diameter, can be pushed over the cable and the cable sleeve. Behind the cable sleeve, by screwing the ring into the base body the retaining nut is thus fixed on the cable behind the cable sleeve. A screw connection of the retaining nut with a counterpart of a threaded cable connection is thus possible, the cable sleeve being at the same time fixed and held between the counterpart and the retaining nut.

For better screwing on of the retaining nut on a counterpart of a threaded cable connection, at least one actuation region is also provided on the outer surface of the retaining nut. The retaining nut preferably has two, four, or six actuation regions on its outer side. These are provided for actuating the retaining nut with a tool, for example an open-end wrench or a pliers. Due to the actuation regions distributed regularly over the circumference of the retaining nut, a positive-fitting gripping and actuation of the retaining nut is possible. Thus, a force, preferably a torque, can be transmitted to the retaining nut and this nut can be fastened to or released from a counterpart of a threaded cable connection.

A further preferred embodiment provides that at least one second actuation region is provided on the ring, which can be screwed into the base body of the retaining nut. The second actuation region on the ring is used to exert a force, preferably a torque, on the ring and to screw it into the base body of the retaining nut in this way. The second actuation region can be designed as a slot for using a screwdriver, as surfaces for using an open-end wrench or for example a hexagon socket wrench, or on another type of actuation region known to the person skilled in the art from the prior art.

### EMBODIMENT

An embodiment of the invention is shown in the drawings and is explained in more detail below. In the drawings:

FIG. 1a shows a perspective view of a retaining nut according to the invention;

FIG. 1b shows a sectional view of the retaining nut according to the invention;

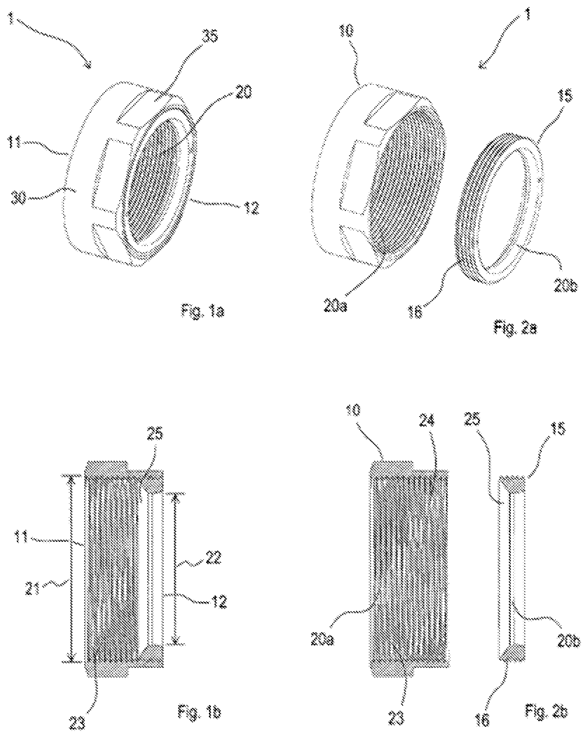

FIG. 2a shows further perspective view of the retaining nut according to the invention;

FIG. 2b shows a further sectional view of the retaining nut according to the invention;

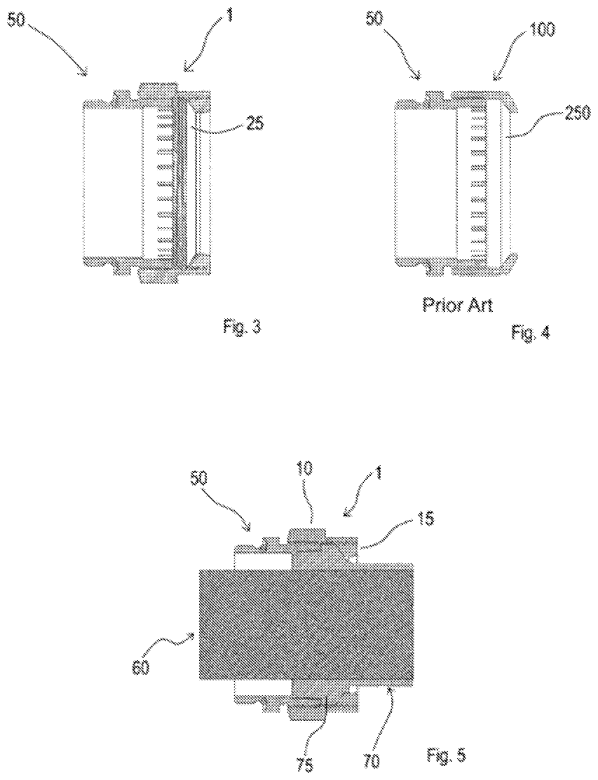

FIG. 3 shows a sectional illustration of the retaining nut according to the invention on a counterpart of a threaded cable connection;

FIG. 4 shows a sectional illustration of a retaining nut known from the prior art on a counterpart of a threaded cable connection;

FIG. 5 is a sectional view of the retaining nut according to the invention mounted with a cable, a cable sleeve, and a counterpart of a threaded cable connection:

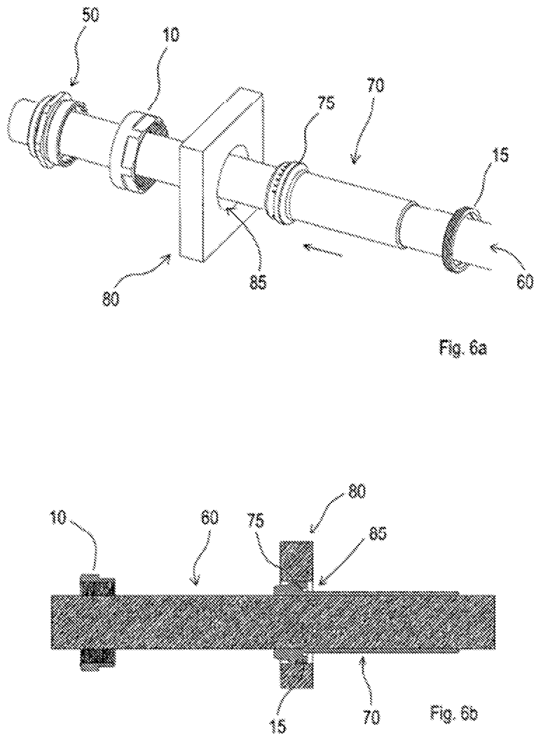

FIG. 6a shows a perspective installation situation of the retaining nut according to the invention; and

FIG. 6b shows the installation situation from FIG. 6a in a sectional view.

FIG. 1a shows a perspective view of a retaining nut 1 according to the invention. The retaining nut 1 is annular and has an inner surface 20 and an outer surface 30. The inner surface 20 situated in the retaining nut 1 is accessible from a screw-in side 11 at the rear side in the illustration, and from a feedthrough side 12. The view of FIG. 1a enables the view of the feedthrough side 12 onto the inner surface 20 of the retaining nut 1.

Six first actuation regions 35 distributed over the circumference of the retaining nut 1 are arranged on the outer surface 30 of the retaining nut 1. The actuation regions 35 are provided on the retaining nut 1 in such a way that a force can be exerted on the retaining nut 1 by means of an open-end or ring wrench or also by pliers. The force, which expediently acts as a torque on the retaining nut 1, is useful for screwing the retaining nut 1 onto or off of a counterpart of a threaded cable connection.

The retaining nut 1 known from FIG. 1a is shown in FIG. 1b in a sectional view. On the screw-in side 11 shown on the left, the retaining nut 1 has a first inner diameter 21 on its inner surface 20. On the feedthrough side 12, which is opposite the screw-in side 11, the retaining nut 1 has a second inner diameter 22. Here the second inner diameter 22 is smaller than the first inner diameter 21.

In the region in which the first inner diameter 21 transitions into the second inner diameter 22, the inner surface 20 forms a pressing region 25. The pressing region 25 tapers conically. That is, the first inner diameter 21 forms a widest diameter of the conical pressing region 25, while the second inner diameter 22 forms a narrowest diameter of the conical pressing region 25.

A first internal thread 23 is formed in the region of the inner surface 20 shown on the left. The free inner diameter of the first internal thread 23 here forms the first inner diameter 21. The first internal thread 23 is here open towards the screw-in side 11 of the retaining nut 1. A counterpart of a threaded cable connection can thus be introduced into the retaining nut 1 via the screw-in side 11. In this case, an external thread provided on the counterpart interacts with the first internal thread 23 of the retaining nut 1 such that the retaining nut 1 can be screwed onto the counterpart.

FIG. 2a shows a further perspective view of the retaining nut 1 from the same view as in FIG. 1a. However, FIG. 2a shows the retaining nut 1 in an exploded view that the individual parts of the retaining nut 1 are shown separately. Here, a base body 10 is shown in the left region of FIG. 2a and a ring 15 is shown in the right region. The ring 15 has an external thread 16 on its outer surface. The ring 15 can thus be screwed into the base body 10 by means of the external thread 16. The base body 10 and the ring 15 together form the retaining nut 1.

A sectional illustration of the retaining nut 1 shown in FIG. 2a with separated base body 10 and ring 15 is shown in FIG. 2b. The inner surface 20 extends both via the base body 10, in which it forms a first inner surface 20a, and also via the ring 15, in which it forms a second inner surface 20b. The inner surface 20a in the base body 10 is formed from the first internal thread 23 and a second internal thread 24. Here the second internal thread 24 is formed in the main body 10 in the region of the feedthrough side 12. In this specific embodiment, the first internal thread 23 and the second internal thread 24 are fashioned identically. The first internal thread 23 and the second internal thread 24 thus go over each other. Here, embodiments are also conceivable in which the first internal thread 23 and the second internal thread 24 have different dimensions, gradients, or sizes.

In the exemplary embodiment shown, the pressing region 25 of the retaining nut 1 is expediently provided on the second inner surface 20b, which is formed on the ring 15. The pressing region 25 is here provided as a bevel on the inside of the ring 15. When the ring 15 is screwed into the base body 10, the bevel accordingly forms the conical pressing region 25, which connects the first inner diameter 21 to the second, smaller inner diameter 22, as shown in FIG. 1b.

The retaining nut 1 of FIG. 1a/b is shown together with a counterpart 50 of a threaded cable connection in FIG. 3 in a sectional view. The retaining nut 1 is shown in the right-hand region, while in the left-hand region the counterpart 50 projects into the screw-in side 11 of the retaining nut 1. Advantageously, an external thread is formed on the counterpart 50, which interacts with the first internal thread 23 of the retaining nut 1.

As is known from the prior art, the counterpart 50 also has a flange and a second thread next to the external thread for screwing on the retaining nut 1. By means of the second thread, indicated here at the left of the flange, the counterpart can be accommodated in an opening of a mounting surface and fixed on this mounting surface. Depending on the application, the mounting surface can be a plug connector housing, a device wall, a motor, or some other machine. Many applications in which a cable has to be mechanically fixedly connected to a mounting surface are conceivable and known.

The region between the pressing region 25 of the inner surface 20 and the counterpart 50 can also be seen clearly in FIG. 3. This gap between the retaining nut 1 and the counterpart 50 is provided for receiving a sealing part. The sealing part is clamped between an end face of the counterpart 50 and the pressing region 25 in such a way that it exerts a radially inwardly-directed force by elastic deformation. A cable received in the sealing part can thus be clamped mechanically and in an environment-tight manner. The necessary force for clamping between the retaining nut 1 and the counterpart 50 is generated by the interaction of the first internal thread 23 of the retaining nut and the external thread of the counterpart 50.

FIG. 4 shows a retaining nut 100 with a counterpart 50, known from the prior art, in comparison with the retaining nut 1 according to the invention. It can be seen that the retaining nut 100 is formed in one piece. The pressing region 250 is an integral part of the one-piece retaining nut. As a result, a feedthrough through which the retaining nut 100 can be guided must correspond to at least the external dimensions of the retaining nut 100, or be larger. In the case of the retaining nut 1 according to the invention, however, the ring 15 can be separated from the base body 10, as a result of which a feedthrough can also correspond to the first inner diameter 21.

The complete installation situation of the retaining nut 1 according to the invention with counterpart 50, a cable 60, and a cable sleeve 70 is shown in FIG. 5 in a further sectional view. The cable 60 is guided through the retaining nut 1. That is, the cable 60 is inserted into the retaining nut 1 at the feedthrough side 12 and comes out again at the screw-in side 11.

The cable sleeve 70 is arranged around the cable 60. The cable sleeve 70 can here be pushed onto the cable 60 as a separate part. As is known to the person skilled in the art, however, the cable sleeve 70 can also be sprayed onto the cable 60 by a second injection process, for example, and can thereby be connected thereto. This has no further relevance for the present invention.

The cable sleeve 70 has a sealing part 75 which forms an integral part of the cable sleeve 70 as a thickening. The sealing part 75 here surrounds the cable sleeve 70 completely. As also known from the prior art, the sealing part 75 is provided to be clamped between the retaining nut 1 and the counterpart 50. The conical pressing area 25 of the inner surface 20 not only transmits a force to the counterpart 50, but also transmits a radially inwardly-directed force to the sealing part 75. The elastically formed sealing part 75 is preferably made of a plastic or rubber. This enables a transmission of the radial force to the cable 60 and at the same time enables an environmentally tight connection between the cable and the threaded cable connection.

The installation situation of the object according to the invention is shown once again by way of example in FIGS. 6a and 6b. FIG. 6a shows a perspective view, while FIG. 6b shows a sectional view. An opening 85 on a housing wall 80 is assumed. Here the opening 85 is dimensioned such that the retaining nut 1 cannot be guided through the opening 85. As a result of the production, the cable 60 is supplied with a cable sleeve 70 already sprayed on and connected fixedly to the cable 60. Since the cable sleeve 70 is already present on the cable 60, no retaining nut 100, as known from the prior art, can be guided onto the cable 60. The sealing part 75 of the cable sleeve 70 is too thick for this.

According to the invention, the ring 15 has already been arranged on the cable 60 before the cable sleeve 70 is applied. When the cable 60 is installed through the opening 85, the cable 60, the cable sleeve 70, and the ring 15 can be guided through the opening 85. In this case, the components are guided from the shown right side through the opening 85 of the housing wall 80.

The base body 10 and the counterpart 50 can then be subsequently arranged on the cable 60 and connected to the ring 15. The entire, fully assembled threaded cable connection, consisting of cable 60, cable sleeve 70, retaining nut 1, and counterpart 50, can be fastened, in a further step, to a mounting surface in an opening.

### LIST OF REFERENCE SIGNS

1/100 retaining nut
10 main body
11 screw-in side
12 feedthrough side
15 ring
16 external thread
20 inner surface
20a first inner surface
20b second inner surface
21 first inner diameter
22 second inner diameter
23 first internal thread
24 second internal thread
25/250 pressing region
30 outer surface
35 first actuation region
50 counterpart
60 cable
70 cable sleeve
75 sealing part
80 housing wall
85 opening
100 retaining nut

1. A retaining nut (1) having an inner surface (20) and an outer surface (30), as well as a screw-in side (11) and a feedthrough side (12), wherein the inner surface (20) on the screw-in side (11) has a first inner diameter (21) and is provided with a first internal thread (23),
wherein the free inner diameter of the first internal thread (23) forms the first inner diameter (21),
wherein the inner surface (20) on the feedthrough side (12) has a second inner diameter (22),
wherein the second inner diameter (22) is smaller than the first inner diameter (21),
characterized in that
the retaining nut (1) is designed in two parts,
wherein the two-part retaining nut (1) consists of a base body (10) and a ring (15).

2. The retaining nut (1) according to claim 1, characterized in that
the ring (15) can be inserted into the base body (10) of the retaining nut (1) and the base body (10) encloses the ring (15) at least in regions,
wherein the inner surface (20) forms a first inner surface (20a) on the base body (10) and forms a second inner surface (20b) on the ring (15).

3. The retaining nut (1) according to any of claims 1 or 2, characterized in that
the ring (15) has an external thread (16) and the base body (10) has a second internal thread (24) arranged on the feedthrough side (12),
wherein the external thread (16) can be screwed into the second internal thread (24).

4. The retaining nut (1) according to claim 3, characterized in that
the second internal thread (24) and the first internal thread (23) merge into one another.

5. The retaining nut (1) according to any of claims 1 to 4, characterized in that
the first inner diameter (21) is arranged on the main body (10) and the second inner diameter (22) is arranged on the ring (15).

6. The retaining nut (1) according to any of claims 1 to 5, characterized in that
the inner surface (20) tapers conically in a pressing region (25) between the first inner diameter (21) and the second inner diameter (22).

7. The retaining nut (1) according to any of claims 1 to 6, characterized in that
on the outer face (30), at least one first actuation region (35) is provided, which is designed to grip and rotate the retaining nut (1) in a positive-fitting manner.

8. The retaining nut (1) according to any of claims 1 to 7, characterized in that
at least one second actuation region is provided on the ring (15), said second actuation region being designed for the positive-fitting rotation of the ring (15).
